(19) United States
(12) Patent Application Publication
(10) Pub. No.: US 2024/0262211 A1
(43) Pub. Date: Aug. 8, 2024

(54) DEVICE FOR CONTROLLING AN ELECTRIC DRIVE OF A TRAILER VEHICLE, SYSTEM THEREWITH AND METHOD THEREFOR

(71) Applicant: ZF CV Systems Global GmbH, Bern (CH)

(72) Inventors: Dirk Hillbring, Celle (DE); Janik Ricke, Uetze (DE); Thomas Kattenberg, Vechelde (DE)

(21) Appl. No.: 18/630,666

(22) Filed: Apr. 9, 2024

Related U.S. Application Data
(63) Continuation of application No. PCT/EP2022/076566, filed on Sep. 23, 2022.

(30) Foreign Application Priority Data
Oct. 22, 2021 (DE) 10 2021 127 440.0

(51) Int. Cl. B60L 7/26

(52) U.S. Cl. CPC B60L 7/26; B60L 2200/28

(57) ABSTRACT

A device is for controlling an electric drive of a trailer vehicle and includes a manual operating unit, which can be arranged in a driver's cab of a towing vehicle, for generating and outputting a request signal for the electric drive in response to a manual selection using the operating unit or a manual input into the operating unit, and a control unit, in particular a brake control unit, of a towing vehicle for receiving the request signal, generating a control signal on the basis of the request signal and outputting the control signal to an electric drive of the trailer vehicle or to a trailer brake control unit of the trailer vehicle. A method is for controlling an electric drive of a trailer vehicle via the device.

### CROSS-REFERENCE TO RELATED APPLICATIONS

This application is a continuation application of international patent application PCT/EP2022/076566, filed Sep. 23, 2022, designating the United States and claiming priority from German application 10 2021 127 440.0, filed Oct. 22, 2021, and the entire content of both applications is incorporated herein by reference.

### TECHNICAL FIELD

The disclosure relates to controlling an electric drive of a trailer vehicle. A trailer vehicle is drawn by a towing vehicle, which is a utility vehicle, for example. Such trailer vehicles drawn by utility vehicles, subsequently also called “trailers” for short, are in particular semitrailers and drawbar trailers.

### BACKGROUND

Utility vehicles that include not only an internal combustion engine as the primary drive source but additionally at least one electric drive for support are known. The electric drives in the utility vehicles are used for example in order to be able to operate the internal combustion engine in an energy-efficient speed range or to provide additional boost, for example when starting up or during hill climbs. In addition, electric drives can be used to recover kinetic and potential energy of the vehicle and to store it as electrical energy in one or more energy stores.

In addition, it is likewise known that utility vehicles in the form of trailer vehicles can also be equipped with an electric drive in order to use the trailer vehicle to provide additional drive force for a utility vehicle in the form of a towing vehicle, for example during a hill climb. Further, the electric drive in the trailer vehicle is also used to support a required negative acceleration, specifically for braking. Friction brakes of the vehicle/trailer combination consisting of the towing vehicle and at least one trailer vehicle can thus be protected. Accordingly, the electric drive can be operated in regenerative mode in order to convert kinetic or potential energy of the vehicle/trailer combination into electrical energy and thus to charge batteries for the electric drive that are provided in the trailer vehicle, for example.

An electric drive of a trailer vehicle, based on the prior art, is often driven by a control unit of the trailer vehicle itself, which is a brake control unit of the trailer vehicle (TEBS), for example. As such, the electric drive can be used efficiently even if the towing vehicle has no provision for control for the electric drive. Other sensors of the trailer vehicle are connected to the trailer brake control unit in such a case in order to control the electric drive independently to assist the driving of a vehicle/trailer combination. In addition, however, there may also be provision for a brake control unit of a towing vehicle to generate signals on the basis of a driving state of the towing vehicle or the vehicle/trailer combination and to transmit the signals to the control unit of the trailer vehicle. These signals can then likewise be used to control the electric drive in the control unit.

As such, fully automated control of the electric drive is produced that goes essentially unnoticed by a driver but that nevertheless facilitates efficient use of the electric drive to support an internal combustion engine of the vehicle, for example, or to stabilize driving. At the same time, the control ensures that batteries or storage batteries of the trailer vehicle are charged for the aforementioned support in suitable situations.

Nevertheless, it has been found that in certain situations, some of which cannot be recognized, or can be recognized inadequately, by the systems for control, fully automated control of an electric drive results in the electric drive being operated in a manner that is unsuitable for these situations or inefficiently.

Many other special cases are conceivable in which purely automated and independent control of the trailer vehicle does not work efficiently. By way of example, a trailer control unit of a refrigerated trailer may provide for there to always be provision for a minimum residual energy in the energy store for operating the cooling units, which are operated using the same batteries as the electric drive, for example in order to maintain cooling in break times. This residual energy is maintained by a fixed setting, for example, even when a dry run is being performed with the refrigerated trailer, which means that this residual energy therefore cannot be used for the electric drive. Rather, the residual energy could be used in such a case to support the drive when this is possible or necessary. Other such situations ensure that, at least in part or at times, the potential of the electric drive is not completely exhausted.

### SUMMARY

It is an object of the present disclosure to overcome the problems of the prior art. Further, the aim is preferably to improve the integration of an electric drive into a trailer vehicle, so that an electric drive can be incorporated into preferably any driving situations with a high level of efficiency and at the same time safety and stability systems of the vehicle are supported. The aim is preferably to find at least one alternative to what is known from the prior art.

The disclosure accordingly relates to a device for controlling an electric drive of a trailer vehicle. The device includes: a manual operating unit configured to be arranged in a driver's cab of a towing vehicle and to generate and output a request signal for the electric drive in response to a manual selection using the manual operating unit or a manual input into the manual operating unit; a control unit of the towing vehicle configured to: receive the request signal; generate a control signal on a basis of the request signal; and, outputting the control signal to the electric drive of the trailer vehicle or to a trailer brake control unit of the trailer vehicle.

The disclosure relates to a device for controlling an electric drive of a trailer vehicle. The device includes a manual operating unit, which is configured to take a manual selection using the operating unit or a manual input into the operating unit as a basis for generating a request signal. Particularly preferably, the operating unit can be arranged in a driver's cab, also referred to as a cab. The request signal preferably is or includes a torque request for the electric drive. Further, the device includes a control unit of a towing vehicle. The control unit is either a separate control unit that can use other connections, for example, to a vehicle bus, to receive other information about the driving state of the towing vehicle. Particularly preferably, the control unit is a brake control unit. The control unit is configured to receive the request signal and to take the request signal as a basis for generating a control signal. Further, the control unit is used to output the control signal to an electric drive of the trailer vehicle or to a trailer brake control unit.

Accordingly, an option is provided for a driver to manually influence the control of an electric drive of the trailer vehicle. A control unit in the driver's cab allows the driver to generate a request signal by input or selection in order to control the electric drive on the basis of this request signal. This involves the request signal being sent not directly to the electric drive, however, but rather to the control unit, which is preferably a brake control unit of a towing vehicle. The control unit, in particular the brake control unit, as a central unit of the vehicle, preferably knows the driving state of the towing vehicle, specifically in particular a current velocity, load data and slippage values, in order to take the request signal as a basis for generating a suitable control signal for the electric drive. Direct manual control of the electric drive, that is, forwarding the request signal directly to another control unit of the electric drive, would accordingly, in certain driving situations, lead to control of the electric drive that could endanger the stability of the vehicle/trailer combination including the towing vehicle and the trailer vehicle.

Processing the request signal in the control unit or brake control unit of the towing vehicle and generating the control signal in this control unit, specifically in particular in the brake control unit, on the basis of the data available therein accordingly leads to prevention of the electric drive from being controlled incorrectly by a driver. Nevertheless, the operating unit allows the driver to influence control of the electric drive in suitable situations.

According to a first embodiment, the device has access protection. The access protection is used to output a request signal after a successful authentication or to process the request signal in the control unit, in particular brake control unit. Otherwise, if an authentication is unsuccessful, the device is configured to ignore a selection or input, that is, not to generate a request signal, or to reject the request signal in the control unit, in particular brake control unit, that is, not to generate a control signal on the basis of the request signal.

Access protection can ensure that only drivers who can successfully authorize themselves, with the result that authorization is provided for the driver, are permitted to influence the electric drive. In principle, it is certainly true that the control unit, in particular brake control unit, ensures that no unstable driving situations arise during the current journey as a result of the request signal. Nevertheless, control of the electric drive, for example including a constantly adjusted propulsion of the electric drive, for example for maneuvering purposes, can result in an accident situation, because the driver does not immediately bring the trailer vehicle to a standstill, as is customary without the control, through customary braking using a brake pedal. In this respect, it is advantageous for the driver to be provided with instruction for such applications of manual intervention in the control of the electric drive, for example for maneuvering purposes. The access protection therefore allows use of the operating unit to be limited to a group of persons who have received such instruction.

According to another embodiment, the access protection includes retrieval of access data, valid access data resulting in an authentication being successful and authorization being performed and invalid access data resulting in an authentication being unsuccessful and authorization being denied. Alternatively or additionally, the access protection includes retrieval of data from a driver card, valid data in the retrieved data resulting in an authentication being successful and authorization being performed or invalid access data resulting in an authentication being unsuccessful and authorization being denied.

Accordingly, authorization is provided on the basis of access data in order to allow the persons who have knowledge of valid access data to use the operating unit to control the electric drive. Transfer of valid access data affords the advantage that the transfer is easily possible, for example after brief instruction. Nevertheless, this option carries the risk of the valid access data also being transferred by already authorized users to personnel that have not yet received instruction. In this respect, another option is to use data for accessing the operating unit of the device that are stored on the driver card for the access protection. Simple transfer of such data is not possible, which means that the driver card first needs to be updated after instruction is provided. This embodiment is particularly safe, in particular in the case of a configuration of the device that affords particularly comprehensive influence on the electric drive, but on the other hand represents more complex organization of the authorization.

According to another embodiment, the request signal includes a torque request value for a requested positive torque or a requested negative torque. The torque request value is dependent on the selection or the input. Further, the control unit, in particular brake control unit, is configured to take the torque request value and a vehicle state as a basis for outputting a control signal containing a setpoint torque value for the electric drive. Accordingly, a desired value of a torque requested by the driver, specifically a torque request value, is sent to the control unit, in particular brake control unit, as the request signal. This value can be selected by a driver by way of a selection or input using the operating unit. The control unit, in particular brake control unit, then checks this value on the basis of the vehicle state and transfers it, for example if the vehicle state so permits, directly as a setpoint torque value. If the vehicle state reflects that the vehicle is in a driving state that is already at a stability limit, for example, then the torque request value, if implementation thereof would take the driving state of the vehicle to an unstable driving state, for example, is transferred only as a setpoint torque value, which differs slightly from a current setpoint torque value, for example, that is currently sent to the electric drive on the basis of an automatic mode. It is also conceivable for a setpoint torque value that is 0 to be output to the electric drive in the case just cited.

According to another embodiment, the control unit, in particular brake control unit, is configured to determine the vehicle state on the basis of a vehicle velocity received or detected by the control unit, in particular brake control unit, and/or a slippage of at least one wheel and/or a detected activity of at least one driver assistance system. Driver assistance systems include an electronic stability program (ESP) or an antilock braking system (ABS), for example. The information relating to the vehicle velocity, a slippage or the activities of driver assistance systems are available to control units, in particular if they correspond to a modern brake control unit, anyway, which means that such control units, in particular brake control units, do not need to have their functionality modified in this regard in order to form the device. Rather, the already available information about the vehicle can be used to ascertain the state of the vehicle, that is, the vehicle state. On the basis of this ascertainment, it is then possible to decide on the extent to which the torque request value is converted into a setpoint torque value.

According to another embodiment, the request signal includes a function request for the electric drive. The function request is dependent on the selection or the input using the operating unit. The control unit, in particular brake control unit, is configured to take the function request and a vehicle state as a basis for outputting a control signal containing a setpoint torque value or a function call for the electric drive.

Accordingly, the request signal is not or not only used to transmit a request for a torque value to the control unit, in particular brake control unit, but rather a function request, for example for selecting an operating mode, can be transmitted. This allows not only a request for a specific torque of the electric drive but also the behavior of the electric drive during an automatic mode with varying torques to be able to be adapted.

According to another embodiment, the operating unit can be used to select multiple function requests that each correspond to one of multiple different operating modes. These operating modes that can be requested in this way include an operating mode for deactivating, reducing or activating an automatic regeneration mode of the electric drive here. This operating mode is used to suppress the activation of the regeneration mode if a controller of the electric drive detects that a regeneration, that is, a regenerative mode of the electric drive, is supposed to be activated. Alternatively, this operating mode is used to reduce the level of automatic regeneration, for example by a percentage that, together with the selectable operating mode, is likewise selectable. Further, the regeneration mode can also be completely switched off in this operating mode, which means that the electric drive does not switch to the regeneration mode while this mode is activated.

Another operating mode included among the selectable operating modes may be suppressing, reducing or deactivating automatic driving for the electric drive. Similarly, in this operating mode it is thus possible to prevent the electric drive from producing a propulsion for the vehicle trailer, that is, a drive torque, if there would normally be provision therefor on the basis of a driving situation in the automatic mode. The level of assistance by the electric drive can likewise be reduced.

Another operating mode is enabling or activating the automatic regeneration mode or the electric drive after an operating mode in which the regeneration mode or the electric drive has been suppressed, reduced or deactivated, for example, has previously been selected. The electric drive or the regeneration mode is then automatically activated again according to its controller, for example, when a driving situation so requires.

Another selectable operating mode may be setting a torque distribution between retarders of the towing vehicle and the electric drive. Together with the function request relating to this operating mode, the operating unit is used for example to specify a percentage split or a ratio that indicates when a continuous braking function is desired or activated and the extent to, or ratio with, which the retarders and the electric drive perform this continuous braking function.

Another operating mode from the selectable operating modes may be specifying a desired state for the state of charge of a battery of the electric drive. This likewise allows the operating unit to be used to specify the state in this operating mode. The operating unit can thus be used to specify a state for the state of charge, for example a percentage or a residual capacity that must either not be exceeded or be undershot. The control unit, in particular brake control unit, then produces setpoint torque values in order to reach or maintain this state. As such, the electric drive is then automatically operated either in the regeneration mode or for a propulsion by its control unit using the setpoint torque values. Another settable operating mode includes setting the level of traction assistance by the electric drive. The operating unit can thus likewise be used to set the extent to which traction assistance is supposed to be provided by the electric drive. The implementation again takes place in the control unit, in particular brake control unit, of the towing vehicle, which produces setpoint torque values such that the selected level is met.

According to another embodiment, the device is configured to output at least one or each selection or at least one or each input made using the operating unit via an interface, or to have it/them logged by a tachograph. The interface is preferably a fleet management interface (FMS). Logging the selection or input facilitates traceability of control by the driver, in particular in the event of an accident situation.

According to another embodiment, the operating unit corresponds to a retarder lever. Alternatively or additionally, the operating unit can be integrated into a retarder lever or another operating unit in the driver's cab of a vehicle. That is, that the operating unit is configured in such a way that it corresponds to the retarder lever, for example. In this case, there is provision for a selection button next to the retarder lever, for example, in order firstly to select the conventional retarder function using the retarder lever or secondly to generate request signals using the retarder lever. Alternatively or additionally, the operating unit can be integrated into the retarder lever, and so the retarder lever has keys or selector switches added, for example, in order to firstly request the usual retarder functions during operation of the retarder lever and secondly to generate the request signals according to the disclosure.

According to another embodiment, at least part of the retarder lever corresponds to the operating unit. That is, that at least part of the operating unit is integrated in a retarder lever. The first retarder levels thus primarily involve the electric drive being used to produce a braking action, for example, and the higher levels, when a braking request with a higher torque is signaled, additionally involve the conventional retarders being controlled.

According to another embodiment, the operating unit can be integrated into another operating unit, specifically into one of the other operating units for operating the towing vehicle. Good attainability by the driver and, following practice, intuitive selection or input using the actuator are therefore possible.

According to another embodiment, the operating unit can be connected to a bus, in particular a CAN bus, particularly preferably a vehicle CAN bus, which can also be connected to the control unit, in particular brake control unit. The request signals can therefore be transmitted to the control unit, in particular brake control unit, via an already available bus without further data lines.

Alternatively or additionally, the control unit, in particular brake control unit, has an interface for the operating unit and the operating unit is connected to the control unit, in particular brake control unit, via the interface for the purpose of directly interchanging data. This allows additional data traffic to be avoided on the vehicle bus and a particularly fast reaction by the control unit, in particular brake control unit, to request signals is possible.

According to another embodiment, the device includes another interface in order to be directly connected to a trailer brake control unit or a control unit for controlling the electric drive. The other interface is preferably a radio interface. Further request signals are sent directly to the trailer brake control unit or the control unit for controlling the electric drive via the other interface. The further request signals preferably include function requests for selecting the or some of the aforementioned operating modes or other operating modes.

The other operating modes include in particular switching on the trailer vehicle, this being able to cover all electrical systems of the trailer vehicle that are switched on. Another additional or alternative other operating mode is switching off the trailer vehicle, this too preferably covering all functions of the trailer vehicle that are switched off. Another additional or alternative other operating mode is for example switching on auxiliary loads, in particular sockets of the trailer vehicle, or switching off auxiliary loads, in particular sockets of the trailer vehicle. Another additional or alternative other operating mode is providing a control signal for controlling a power, in particular a maximum power, that is drawn from a battery of the towing vehicle by auxiliary loads.

Other operating modes that therefore do not require the interaction of the control unit, in particular brake control unit, as a checking or correcting instance are sent directly to the control unit of the electric drive, which is the trailer brake control unit, for example, using the radio interface. An additional data line between the operating unit and the trailer vehicle is not necessary in the case of a radio interface. Furthermore, functions that are not able to be carried out by specifying a setpoint torque from the control unit, in particular brake control unit, to the trailer brake control unit can thus be performed and appropriately selected or input.

According to another embodiment, the operating unit is a lever, in particular a retarder lever or configured in the style of a retarder lever, that includes multiple predefined latching positions. Each latching position corresponds to a different predefined torque request value. Alternatively or additionally, the operating unit is configured with multiple function keys, which can also be represented virtually on a touchscreen, for example. Each function key is associated with a different predefined torque request value and/or with a predefined function request.

In the case of the operating unit in the form of a lever with latching positions, intuitive operation by the driver is easily possible because a driver is used to operating a retarder lever. In contrast to a retarder lever, this has two directions of adjustment, for example, starting from a central position of rest. The front latching positions are used for example to produce positive torque request values as the request signals, and negative torque request values are then produced as the request signals in the opposite rear latching positions. The additionally or alternatively provided function keys allow appropriate functions to be easily selected.

The disclosure also relates to a system having a device according to one of the aforementioned embodiments and having an electric drive of a trailer vehicle and a trailer brake control unit. According to an embodiment of the system, the control unit, in particular brake control unit, includes an interface, specifically a data interface, for the operating unit.

The disclosure also relates to a vehicle/trailer combination including a towing vehicle and a trailer vehicle and also a device according to one of the aforementioned embodiments or a system according to one of the aforementioned embodiments.

The disclosure also relates to a method for controlling an electric drive of a trailer vehicle using a device according to one of the aforementioned embodiments. The method includes generating and outputting a request signal for the electric drive using an operating unit arranged in a driver's cab in response to a selection using the operating unit or an input into the operating unit. Furthermore, the method includes receiving the request signal from the operating unit using a control unit, in particular brake control unit. Further, the method includes generating a control signal, in particular a setpoint torque, on the basis of the request signal using the control unit, in particular brake control unit. Moreover, the method includes outputting the request signal to a control unit of the electric drive of the trailer vehicle or to a trailer brake control unit from the control unit, in particular brake control unit.

### BRIEF DESCRIPTION OF DRAWINGS

The invention will now be described with reference to the drawings wherein:

FIG. 1 shows a towing vehicle with a vehicle trailer,

FIG. 2 shows an operating unit according to an embodiment,

FIG. 3 shows steps of the method according to an embodiment; and,

FIG. 4 shows further steps of the method according to an embodiment.

### DETAILED DESCRIPTION

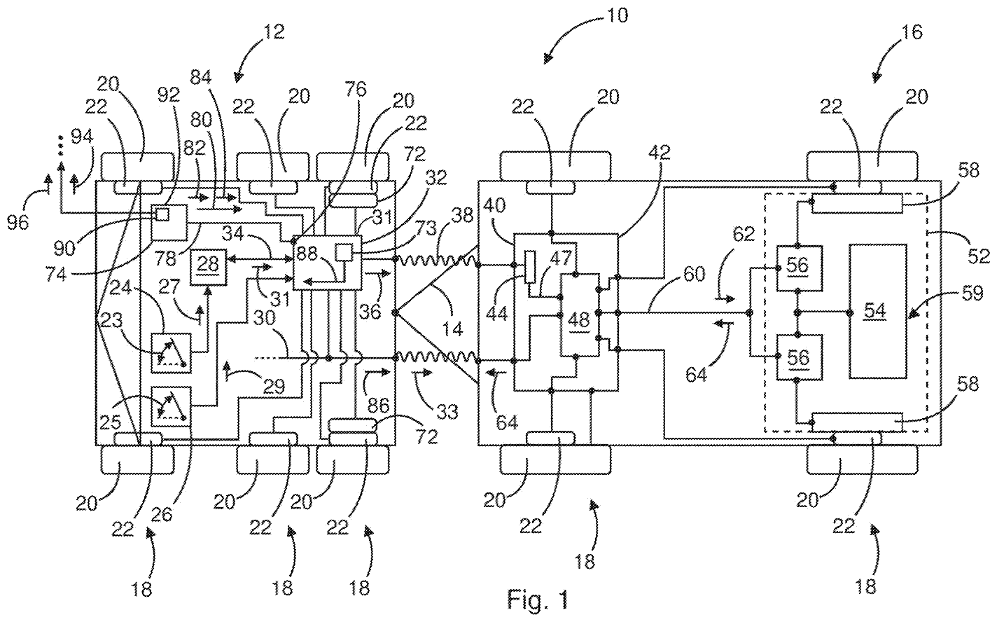

FIG. 1 shows a vehicle/trailer combination 10 including a towing vehicle 12 connected to a trailer vehicle 16 via a drawbar 14. The towing vehicle 12 and the trailer vehicle 16 can each be referred to as a utility vehicle. The towing vehicle 12 and the trailer vehicle 16 each include multiple axles 18 that each include two wheels 20. Each of the wheels 20 has an associated friction brake 22 in order to brake the wheels 20 using the respectively associated friction brakes 22 in the event of a braking request, specifically a requested negative acceleration. At least one of the axles 18 of the towing vehicle 12 is driven by an internal combustion engine or an electric drive, neither the internal combustion engine nor the electric drive being depicted in FIG. 1 for reasons of clarity.

The towing vehicle 12 is driven by virtue of a gas pedal position 23 of a gas pedal 24 being varied, and the towing vehicle 12 is braked by virtue of a brake pedal position 25 of a brake pedal 26 being varied, by a user or driver of the towing vehicle 12 in order to signal a request for a velocity increase 27, or a braking request 29. This is accomplished by virtue of the gas pedal 24 being connected to a vehicle control unit 28. It is accomplished by virtue of the brake pedal 26 being connected to a control unit 31, which here corresponds to a brake control unit 32. The vehicle control unit 28 transmits control signals for controlling the drives, which are not depicted, to a bus that is connected to the vehicle control unit 28 but not depicted. The vehicle control unit 28 further uses the request for a velocity increase 27 to also ascertain a requested positive acceleration, however, and transfers the acceleration to the brake control unit 32 via a connection 34. The brake control unit 32 produces a positive setpoint torque value 33 on a bus 30. Further, the braking request 29 is also sent from the brake pedal 26 to the brake control unit 32. The brake control unit 32 can thus take a desired velocity increase 27 or the braking request 29 as a basis for outputting to the bus 30 a setpoint torque value 33 that is supposed to be produced by an electric drive of the trailer vehicle 16. The brake control unit 32 therefore produces a setpoint torque value 33 for the electric drive that corresponds to a positive value or a negative value. Production takes place automatically in the brake control unit 32.

Further, the friction brakes 22 are connected to the brake control unit 32, and so in the event of a braking request 29 triggered by the brake pedal 26 this braking request 29 can be converted into braking signals for the friction brakes 22.

The brake control unit 32 is further connected to an input 40 of a trailer brake control unit 42 via a brake control line 38. This brake control line 38 is used to additionally transmit a braking request 29 in the form of a brake control pressure 36 to the trailer brake control unit 42. A sensor 44 of the trailer brake control unit 42 converts the brake control pressure 36 transmitted via the brake control line 38 into a signal 47 and transmits this to a controller 48 of the trailer brake control unit 42. This signal 47 can be taken as a basis for controlling friction brakes 22 of the axles 18 of the trailer vehicle 16. The brake control pressure 36 delivered to the trailer brake control unit 42 via the brake control line 38 can therefore be taken as a basis for also controlling the friction brakes 22 of the trailer vehicle 16.

Additionally, the trailer vehicle 16 has the aforementioned electric drive 52, which has a battery 54 that is rechargeable and can also be referred to as a storage battery. Besides the battery 54, the electric drive includes two converters 56 that use the energy from the battery to supply electric motors 58 with energy in order to produce a positive torque. The battery 54, the converters 56 and the electric motors 58 correspond to components 59 of the electric drive 52. According to an alternative embodiment, which is not depicted here, there is provision for one converter 56 per electric motor 58. That is, that if there is provision for only one electric motor 58, the electric drive 52 thus also includes only one converter 56. A single electric motor 58 is used as a central axle drive in combination with a differential gear in a similar manner to an internal combustion engine that acts on one axle in total, for example.

The electric motors 58 can also be operated in the regeneration mode, which can also be referred to as the generator mode, that is, regeneratively, with the result that electrical energy is fed back into the battery 54 via the converters 56. To control the converters 56, the electric drive 52 is connected to the trailer brake control unit 42 via a further bus 60.

Control of the converters 56 firstly specifies whether the electric motors 58 are supposed to be operated in the generator mode or in the motor mode and what torque is supposed to be used in this instance. If the electric motors 58 are operated in the motor mode, the torque is referred to as a positive torque, whereas the torque, that is, a value of the torque, in the regenerative mode of the electric motors 58 is referred to as negative torque. To control the electric drive 52, specifically in particular the converters 56, this is accomplished by virtue of the trailer brake control unit 42 using the bus 60 to send a signal 62 to the electric drive 52. Furthermore, the electric drive 52 sends a status signal 64 to the trailer brake control unit 42 in order to notify the trailer brake control unit 42 of what currently available positive or currently available negative torque or what currently available positive or currently available negative torque change can be provided by the electric drive 52 at the present time, for example. The currently available torques or torque changes are dependent on the current operating state of the electric drive.

Accordingly, the trailer brake control unit 42 is configured to send the status signal 64 back to the brake control unit 32 of the towing vehicle 12 via the bus 30. The status signal 64 can be used to take this into consideration when producing the setpoint torque value 33. Correspondingly, the setpoint torque value 33 is then taken as a basis for sending a torque request signal 62 to the electric drive 52.

Further, at least the towing vehicle 12 has a retarder 72 arranged on each of the wheels 20 on the rear axle 18. The retarders 72 can likewise be activated or adjusted by the brake control unit 32.

The brake control unit 32 therefore controls all the apparatuses for slowing the vehicle velocity, including the friction brakes 22, the retarders 72 and the electric drive 52. The electric drive 52 for producing a propulsion, that is, a positive acceleration, is also facilitated using the brake control unit 32. This incorporation of the apparatuses is performed automatically by the brake control unit 32 on the basis of a current vehicle state 88, which the brake control unit 32 ascertains using a processor 73 from supplied information via the bus 30. A received braking request 29 and the request for a velocity increase 27 are also taken into consideration when ascertaining the vehicle state 88. In particular in the case of a braking request 29, the brake control unit 32 undertakes the splitting of the apparatuses to implement this braking request 29.

According to the disclosure, the towing vehicle 12 now further has an operating unit 74, which is connected to an interface 76 of the brake control unit via a data line 78. The operating unit 74 is used to generate and output a request signal 80 to the brake control unit 32. The request signal 80 corresponds to either a torque request value 82 or a function request 84. The brake control unit 32 is then used to take the request signal 80 as a basis for generating a control signal 86 for the electric drive 52. The control signal 86 is then likewise output via the bus 30 and sent to the trailer brake control unit 42. On the basis of this control signal 86, the electric drive 52 is controlled by the trailer brake control unit 42. The control signal 86 corresponds to the setpoint torque value 33, for example.

In summary, the brake control unit 32 of the towing vehicle 12 thus takes components connected to the brake control unit 32, for example the vehicle control unit 28 and other sensors, not depicted, and also data received via the bus 30, as a basis for ascertaining the vehicle state 88. The control signal 86 is accordingly generated on the basis of this vehicle state 88 and on the basis of the request signal 80.

Furthermore, the operating unit 74 includes another interface 90, which is in the form of a radio interface 92. The radio interface 92 can be used to transmit further request signals 94 directly to the trailer brake control unit 42. These further request signals 94 correspond to further function requirements 96.

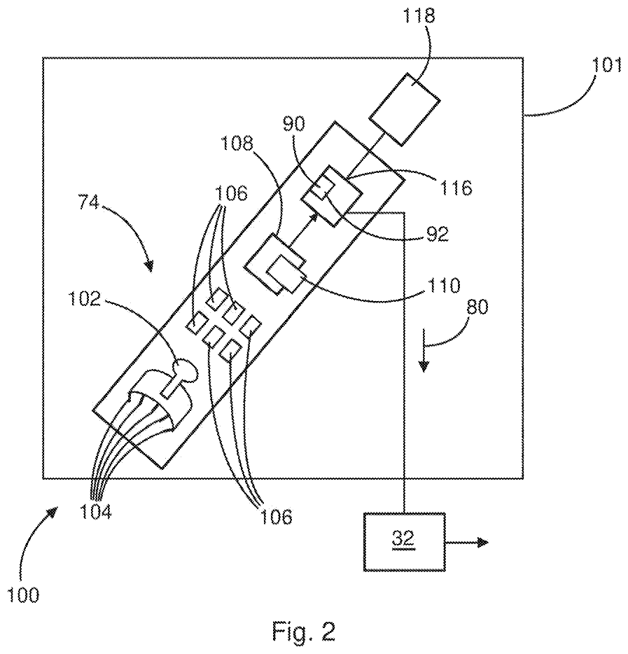

FIG. 2 shows an embodiment of a device 100 for controlling an electric drive 52 of a trailer vehicle 16. The device 100 includes an operating unit 74, as may also be used in the vehicle/trailer combination 10 depicted in FIG. 1. The operating unit 74 is arranged in a driver's cab 101 and includes a lever 102 that has multiple latching positions 104. Each latching position 104 has an associated predefined torque request value 82. Furthermore, the operating unit 74 includes multiple function keys 106. Each of the function keys is used to generate a request signal 80 containing a function request 84.

Further, there is provision for a reader 108 for reading in a driver card 110. According to the embodiment depicted here, the reader 108 is depicted as part of the device 100. According to an embodiment that is not depicted here but covered by the disclosure, the reader 108 is separate from the device 100 and includes a dedicated processor for verifying the access data 112. The device is then connected to the external reader 108 via a data connection and receives clearance from the processor of the external reader 108, following authorization of a user, in order to generate request signals 80. A processor 115 of the device 100 is used to verify access data 112 that are read from the driver card 110. If the access data 112 are valid, authorization is provided and a user is allowed to generate a request signal 80 on the basis of a selection or input using the lever 102 or the keys 106. The reader 108 and the processor 115 can be referred to as access protection 111.

Further, the processor 115 has an interface 116, which is connected to a tachograph 118. The processor 115 records each selection using, or input into, the operating unit 74 by an authorized user and passes it to the tachograph 118 via the interface 116. The processor 115 can be considered part of the operating unit 74 and is therefore used to output the input or selection made using the lever 102 and the keys 106, to generate the request signal 80 and to transmit this request signal 80 to the brake control unit 32. Further, the processor 115 has another interface 90, which is preferably a radio interface 92. This interface 90 can be used by the device 100 to directly communicate with the trailer brake control unit 42.

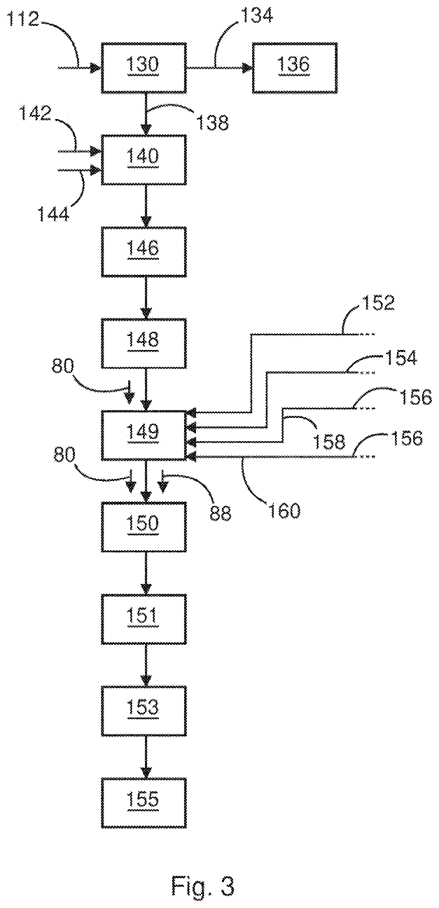

FIG. 3 shows steps for controlling an electric drive of a trailer vehicle 16. Access data 112 are retrieved in a step 130. If these access data 112 are invalid access data 134, control of the electric drive of the trailer vehicle is terminated in step 136. If the access data 112 are valid data 138, then in step 140 a selection 142 or an input 144 is received by the operating unit 74 and in step 146 a request signal 80 is generated on the basis of the selection 142 or the input 144 and is output to the brake control unit 32. The request signal 80 is received by the brake control unit 32 in step 148 and a vehicle state 88 is ascertained in step 149. A control signal 86 is generated on the basis of the request signal 80 and a vehicle state 88 in step 150. The vehicle state 88 is for example on the basis of a vehicle velocity 152, a slippage 154 of at least one of the wheels 20 and/or a detected activity of at least one driver assistance system 156, which includes an ESP 158 or an ABS 160, for example. The control signal 86 is then output in step 151 and received by the electric drive 52 in step 153. The control signal 86 includes a setpoint torque value 33, which is used in step 155 as a specification for the electric drive 52 in order to control the torque of the electric drive 52.

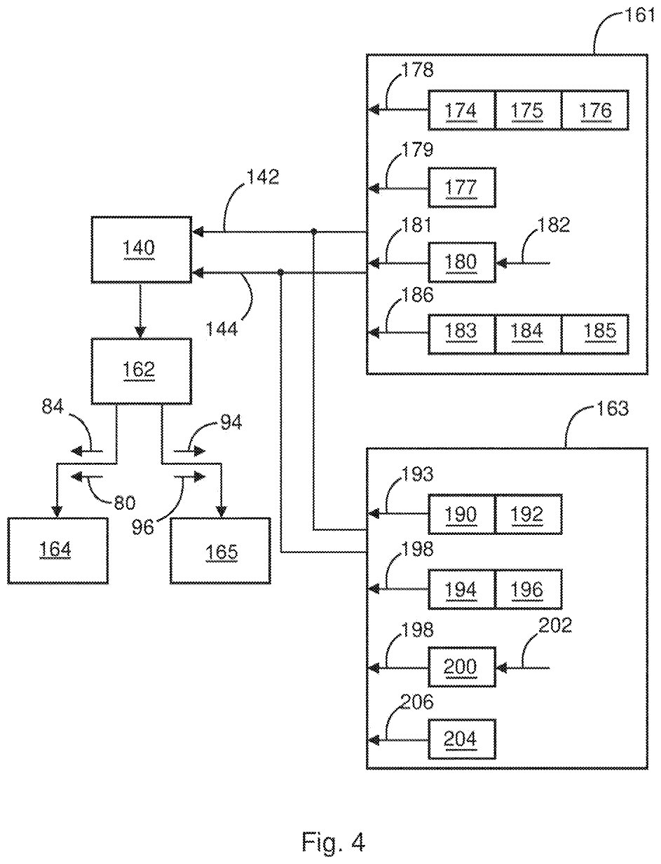

FIG. 4 shows another embodiment for controlling the electric drive 52 of the trailer vehicle 16. First, step 130, not depicted here, is again performed in order to output authorization for a driver to use the device in the event of valid access data 138. In step 140, which now follows in this case depicted here, a selection 142 or an input 144 using the operating unit 74 is received that corresponds to one of multiple operating modes 161 or other operating modes 163. The selected operating mode is taken as a basis for generating a request signal 80 in step 162 if one of the operating modes 161 has been selected. If one of the other operating modes 163 has been selected, a further request signal 94 is generated. Either a request signal 80 including a function request 84 is then output to the brake control unit 32 in step 164, or a further request signal 94 containing a further function request 96 is output directly to a trailer brake control unit 42 using a radio interface 92 in step 165. Operating modes 161 include activating 174, reducing 175 or deactivating 176 an automatic regeneration mode 178 of the electric drive 52, setting 177 a torque distribution 179 between retarders 72 of the towing vehicle 12 and the electric drive 52, setting 180 a level 181 of traction assistance 182 by the electric drive 52 and activating 183, reducing 184 or deactivating 185 automatic driving 186 for the electric drive 52. The other operating modes 163 include switching on 190 or switching off 192 electronics 193 of the trailer vehicle 16 or switching on 194 or switching off 196 auxiliary loads 198 and also providing 200 a maximum power 202 that can be drawn from the battery of the trailer vehicle 16 by auxiliary loads 198 of the trailer vehicle 16 and setting 204 a desired state 206 for the battery of the electric drive 52.

It is understood that the foregoing description is that of the preferred embodiments of the invention and that various changes and modifications may be made thereto without departing from the spirit and scope of the invention as defined in the appended claims.

### List of Reference Signs [Part of the Description]

10 vehicle/trailer combination

12 towing vehicle

14 drawbar

16 trailer vehicle

18 axles

20 wheels

22 friction brake

23 gas pedal position

24 gas pedal

25 brake pedal position

26 brake pedal

27 velocity increase

28 vehicle control unit

29 braking request

30 bus

31 control unit

32 brake control unit

33 setpoint torque value

34 connection

36 brake control pressure

38 brake control line

40 input

42 trailer brake control unit

44 sensor

47 signal

48 controller

52 electric drive

54 battery

56 converter

58 electric motors

59 components

60 bus

62 signal

64 status signal

72 retarder

73 processor

74 operating unit

76 interface

78 data line

80 request signal

82 torque request value

84 function requests

86 control signal

88 vehicle state

90 interface

92 radio interface

94 further request signals

96 further function requests

100 device

101 driver's cab

102 retarder lever

104 latching positions

106 function keys

108 reader

110 driver card

111 access protection

112 access data

115 processor

116 interface

118 tachograph

130 retrieve access data

134 invalid access data

136 terminate control of the electric drive

138 valid access data

140 receive selection or input

142 selection

144 input

146 generate and output a request signal

148 receive request signal

149 ascertain vehicle state

150 generate control signal

151 output control signal

152 vehicle velocity

153 receive control signal

154 slippage

155 use setpoint torque value as specification

156 driver assistance system

158 ESP

160 ABS

161 operating modes

162 generate request signal

163 other operating modes

164 output request signal

165 output further request signal

174 activate regeneration mode

175 reduce regeneration mode

176 deactivate regeneration mode

177 set torque distribution

178 regeneration mode

179 torque distribution

180 set level of traction assistance

181 level of traction assistance

182 traction assistance

183 activate automatic driving

184 reduce automatic driving

185 deactivate automatic driving

186 automatic driving

190 switch on electronics

192 switch off electronics

193 electronics

194 switch on auxiliary load

196 switch off auxiliary load

198 auxiliary load

200 provide maximum power

202 maximum power

204 set desired state

206 desired state

1. A device for controlling an electric drive of a trailer vehicle, the device comprising:
a manual operating unit configured to be arranged in a driver's cab of a towing vehicle and to generate and output a request signal for the electric drive in response to a manual selection using said manual operating unit or a manual input into said manual operating unit;
a control unit of the towing vehicle configured to:
receive said request signal;
generate a control signal on a basis of said request signal; and, outputting said control signal to the electric drive of the trailer vehicle or to a trailer brake control unit of the trailer vehicle.

2. The device of claim 1, wherein said manual operating unit has access protection in order to at least one of output said request signal after a successful authentication and to process said request signal in said control unit; and, in an event of an unsuccessful authentication, to ignore a selection or input and not to generate said request signal or to reject said request signal in said control unit.

3. The device of claim 2, wherein:
the access protection includes a retrieval of access data and valid access data results in an authentication being successful or invalid access data results in an authentication being unsuccessful; or,
the access protection includes the retrieval of access data from a driver card and valid access data results in an authentication being successful or invalid access data results in an authentication being unsuccessful.

4. The device of claim 1, wherein said request signal includes a torque request value for a requested positive or negative torque, said torque request value being dependent on the selection or the input; and, said control unit is configured to take the torque request value and a vehicle state as a basis for outputting the control signal containing a setpoint torque value for the electric drive.

5. The device of claim 1, wherein said control unit is configured to determine at least one of:
a vehicle state on a basis of a vehicle velocity received or detected via said control unit;
a slippage of at least one wheel; and,
a detected activity of at least one driver assistance system.

6. The device of claim 5, wherein the at least one driver assistance system is an ESP or an ABS.

7. The device of claim 1, wherein said request signal includes a function request for the electric drive, the function request being dependent upon the selection or the input; and, said control unit is configured to take the function request and a vehicle state as a basis for outputting the control signal containing a setpoint torque value or a function call for the electric drive.

8. The device of claim 1, wherein a multiplicity of function requests containing different operating modes are selectable via said operating unit, the operating modes including at least one of:
activating, reducing, or deactivating an automatic regeneration mode of the electric drive;
activating, reducing, or deactivating automatic driving for the electric drive;
setting a torque distribution between retarders of the towing vehicle and the electric drive; and,
setting a level of traction assistance by the electric drive.

9. The device of claim 1, wherein the device is configured to at least one of output at least one selection or input via an interface and have the at least one selection logged by a tachograph.

10. The device of claim 1, wherein said manual operating unit corresponds to a retarder lever or can be integrated into the retarder lever or another operating unit in the driver's cab of the towing vehicle.

11. The device of claim 1, wherein said operating unit is connectable to a bus which is connectable to said control unit; or, said operating unit is connected directly to an interface of said control unit.

12. The device of claim 11, wherein the bus is a vehicle bus.

13. The device of claim 1 further comprising:
a further interface configured to interchange data with the trailer brake control unit;
the device being configured to send further request signals directly to the trailer brake control unit.

14. The device of claim 13, wherein the further request signals include further function requests for selecting the operating modes or other operating modes; and, the other operating modes include at least one of:
switching on or switching off the trailer vehicle;
switching on or switching off auxiliary loads of the trailer vehicle;
providing a control signal for controlling a power that can be drawn from a battery of the trailer vehicle by the auxiliary loads; and,
setting a desired state for the battery of the electric drive.

15. The device of claim 14, wherein the power is a maximum power.

16. The device of claim 13, wherein the further interface is a radio interface.

17. The device of claim 1, wherein at least one of:
said operating unit includes a lever having a multiplicity of predefined latching positions, each of said multiplicity of predefined latching position being associated with a predefined torque request value; and,
said operating unit includes a multiplicity of function keys and each of said multiplicity of function key has at least one of an associated predefined torque request value and an associated predefined function request.

18. The device of claim 1, wherein said control unit is a brake control unit.

19. A system comprising the device of claim 1, the electric drive, and a trailer brake control unit.

20. A vehicle/trailer combination having a system as claimed in claim 19.

21. A method for controlling an electric drive of a trailer vehicle via a device for controlling the electric drive of the trailer vehicle, the device including a manual operating unit configured to be arranged in a driver's cab of a towing vehicle and to generate and output a request signal for the electric drive in response to a manual selection using said manual operating unit or a manual input into said manual operating unit; the device further including a control unit of the towing vehicle configured to: receive said request signal, generate a control signal on a basis of said request signal, and, output said control signal to the electric drive of the trailer vehicle or to a trailer brake control unit of the trailer vehicle, the method comprising:
generating and outputting a request signal for the electric drive using an operating unit in response to a selection using, or an input into, the operating unit;
receiving the request signal using a control unit;
generating a control signal on a basis of the request signal using the control unit; and,
outputting the control signal to an electric drive control unit of an electric drive of the trailer vehicle or to a trailer brake control unit by way of the control unit.

22. The method of claim 21, wherein the control unit is a brake control unit.
